(19) United States
(12) Patent Application Publication
(10) Pub. No.: US 2003/0126061 A1
(43) Pub. Date: Jul. 3, 2003

(54) Computer auction system with dynamic pricing

(76) Inventors: David H. Brett, Vancouver (CA); Douglas G. Chepil, Kelowna (CA); Stephen C. Hawtree, Kelowna (CA)

Correspondence Address: Michael G Johnston, Moore & Van Allen, Suite 800, 2200 West Main Street, Durham, NC, 27705, US

(21) Appl. No.: 09/979,326

(22) PCT Filed: Mar. 16, 2001
(86) PCT No.: PCT/CA01/00341

(30) Foreign Application Priority Data
Mar. 16, 2000 (CA) 2,300,751

(51) Int. Cl. G06F 17/60

(52) U.S. Cl. 705/37

(57) ABSTRACT

The present invention is an auction system embodied withn the environment of a digital communications network wherein a server computer system is operatively linkable for bi-directional communications with a plurality of remote terminals, each remote terminal being under the control of a user of the network. Using technology that is well known, the communications network may be conveniently established with the facilities of the Internet and the World Wide Web (WWW); the server computer system being situate at an established web site, the remote terminals being the personal computers of users having access to the Internet, and hence the web site, through selected Internet Service Providers (ISPs). However, while the Internet provides an exemplary telecommunications link for digital communications, it is to be understood that the present invention is not limited to implementation using the Internet.

### FIELD OF THE INVENTION

The present invention relates to a computer based method of managing the sale by auction of commodities and services utilizing a digital communication network linking a server computer system with a plurality of remote terminals. Although not limited, the present invention is particularly adapted for the sale by auction of digital data.

### BACKGROUND TO THE INVENTION

Herein, it is to be understood that the term “digital data” means any data representing information or knowledge and which is capable of being stored in and retrieved from a computer or computer server system, transmitted over a digital channel, and displayed on a computer screen or other display device. Such data may comprise numbers, text or other characters, graphics or other images, and combinations of the foregoing.

Computerized auction systems have become prevalent methods of commerce conducted over the Internet. These online auctions enable buyers and sellers of goods to interact through a variety of systems designed to provide an interactive process whereby prices for auctioned items are established.

Current online auctions allow buyers and sellers to negotiate for items and complete purchases and sales through various payment and fulfillment strategies. Interaction processes vary in the number of items offered for sale in a given auction, the number of winning bidders allowed to purchase items, the increments by which bids can be increased, the manner by which sellers of items can place reserve prices on those items, and other criteria.

Online auctions have incorporated a number of common features designed to foster trust among participants, principally the ability of users to place ratings on the performance of other users with respect to the quality of goods sold by sellers, and the prompt and reliable payment by buyers. Ratings and other feedback systems are typically visible to the public, and thereby enhance confidence in the integrity of the system users.

However, existing online auction systems are generally not adapted to handle the auctioning of digital data any differently from the auctioning of tangible goods. For example, they do not presuppose an effectively unlimited supply of an item to be auctioned (as is the case with digital data). Further, they are not uniquely adapted to manage either the seller's ask price for a digital data item or the delivery of the item in response to successful bids. In other words, the auctioning process as applied to digital data typically will have unduly limited responsiveness to market activity and changing market circumstances.

Accordingly, a primary of the present invention is to provide a new and improved method of offering an item for auction over a digital communications network.

A further object of the present invention is to provide a method of offering an item for auction over a digital communications network which has enhanced responsiveness to market activity and changing market circumstances.

Within the environment of such a network, a further object of the present invention is to dynamically manage the pricing of an auction item in a manner that is especially suitable for cases where the item to be auctioned is in the form of digital data.

In cases where the item to be auctioned is in the form of digital data, a further object of the present invention is to facilitate the prompt delivery of the item in response to successful bids.

### SUMMARY OF THE INVENTION

The present invention is an auction system embodied within the environment of a digital communications network wherein a server computer system is operatively linkable for bi-directional communications with a plurality of remote terminals, each remote terminal being under the control of a user of the network. Using technology that is well known, the communications network may be conveniently established with the facilities of the Internet and the World Wide Web (WWW); the server computer system being situate at an established web site, the remote terminals being the personal computers of users having access to the Internet, and hence the web site, through selected Internet Service Providers (ISPs). However, while the Internet provides an exemplary telecommunications link for digital communications, it is to be understood that the present invention is not limited to implementation using the Internet.

In accordance with a broad aspect of the invention, there is provided a method of offering an item by auction to such users, the method comprising the steps of:

(a) storing item information relating to the item in the server computer system, such item information including:

(i) information identifying the item; and

(ii) information representing a current ask price for the item;

(b) in response to an information request command from any requesting one of the terminals, transmitting the item information from the server computer system to the requesting terminal for display by the requesting terminal;

(c) receiving at the server computer system bid information transmitted by users from the remote terminals, the bid information from each such user including:

(i) information identifying the user sending the bid information;

(ii) information representing the amount bid by such user, and,

(d) analyzing with the server computer system bid information so received and, in response thereto,

(i) automatically raising the current ask price by a controlled amount if a predetermined criteria for doing so is satisfied;

(ii) automatically lowering the current ask price by a controlled amount if a predetermined criteria for doing so is satisfied; and,

(iii) automatically generating an acceptance signal signifying the receipt of an acceptable bid in any case where the bid information satisfies predetermined criteria for acceptance.

The predetermined criteria for raising or lowering a current ask price may vary. However, in a preferred embodiment of the present invention, an ask price is automatically raised if the amounts bid in a predetermined minimum number of bids are at least equal to the current ask price. Conversely, an ask price is automatically lowered if a predetermined minimum number of bids at least equal to the current ask price are not received within a predetermined period of time.

An item offered by auction in the foregoing manner may be any marketable commodity or service, including digital data.

In cases where the auction item is digital data, the method of the present invention advantageously may be reamed to include the step of storing in the server computer system, preferably by uploading from a remote terminal, not only information relating to the item (viz. information relating to the data), and a current ask price for the item, but also the item itself (viz. the data per se). Then, the data may be accessed and downloaded from the server computer system to any one of the remote terminals. In the context of the present invention, such access preferably is permitted to any user who submits a successful bid. The predetermined criteria which the bid information must satisfy for acceptance of a bid may be varied, but obviously would require that the amount bid be at least equal to the current ask price and suitable identification of the person making the bid. Preferably, such information includes credit card information that enables automatic payment of the bid amount.

The foregoing and other features and advantages of the present invention will now be described with reference to the drawings.

### BRIEF DESCRIPTION OF THE DRAWINGS

FIG. 1 is a representational diagram showing a digital communications network with which the auction method of the present invention may be implemented.

FIG. 2 is a flow chart showing basics of an auction process in accordance with the present invention.

### DETAILED DESCRIPTION OF PREFERRED EMBODIMENTS

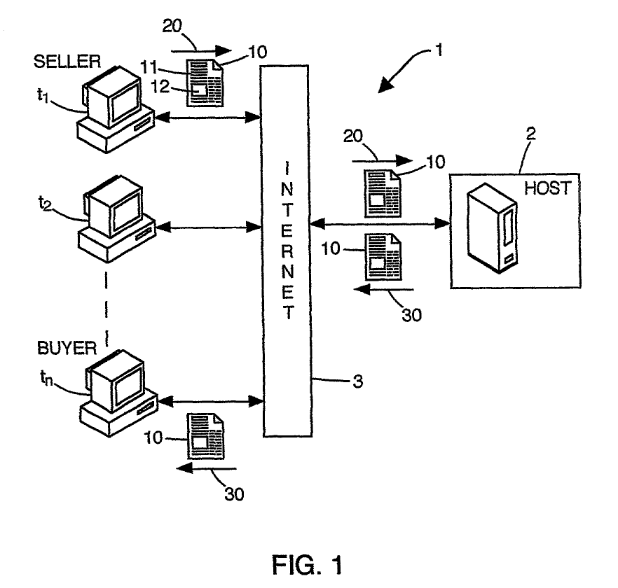

The digital communications network generally designated 1 in FIG. 1 comprises a server computer system 2 and a plurality of remote terminals t₁, t₂ . . . tₙ, . Each terminal t₁, t₂ . . . tₙ is a conventional personal computer associated with a user of the network. Further, each terminal is interconnected by means of a communication link 3 to a server computer system 2 which, apart from programming, is a conventional host computer system

Communication link 3 is provided by the Internet. Server computer system 2 (hereinafter referred to as the HOST) is located at a conventional web site on the Internet. Each terminal t₁, t₂ . . . tₙ is connected to the Internet through a selected ISP and has the capacity to send and receive e-mail via the Internet. It will be readily understood that the Internet permits the greatest number of potential users (potential buyers and potential sellers) to operatively interconnect with server computer system 2 utilizing well known computer and communications hardware, commands and protocols.

For the purpose of the following discussion, it will be assumed that the auction item is digital data. Further, it will be assumed that the person wishing to auction the item is a user (hereinafter referred to as the SELLER) associated with terminal t₁, and that an ultimately successful bidder is a user (hereinafter referred to as the BUYER) associated with teminal tₙ.

By way of overview, the auction item is representationally indicated in FIG. 1 as a digital file 10 comprising text 11 and graphics 12. The file is depicted in transit: firstly along the communication path indicated by arrows 20 from the SELLER's terminal t₁ to the HOST via communication link 3; and, secondly along the communication path indicated by arrows 30 from the HOST to the BUYER's terminal tₙ likewise via communication link 3.

In relation to the SELLER, the preferred method of implementing the auction process is as follows:

(1) The SELLER at terminal t₁ first establishes a communications link via the Internet by going to the web site associated with the HOST.

(2) The HOST provides a prompt through terminal t₁ which invites the SELLER to register with the HOST. When the prompt is exercised, the HOST then presents the SELLER with a number of conventional data entry fields prompting the SELLER to provide information which serves to identify and to facilitate communication with the SELLER. Such information includes a short ID name and a secure password selected by the SELLER, the SELLER's actual first and last names, a physical address, an e-mail address and a telephone number. As well, such information includes credit card information for the SELLER, such information being used by the HOST to automatically bill for any seller fees that accrue, and to apply credit for sales that occur.

After entering the requested information in such fields, the SELLER transmits the information from terminal t₁ to the HOST where the information is encrypted and stored in a registrant's database.

(3) Following registration, the SELLER is prompted for information which more specifically identifies the item (viz. file 10) to be auctioned. Preferably, this information necessarily includes identification of the item within one of a number of predetermined main categories (for example, the category “Agriculture”). Also, the information may include identification of the item within one or more predetermined subcategories. Advantageously, the HOST computer presents the available selections for the main category and each subcategory in conventional scrollable data entry windows or drop down menus which permit the SELLER to point and click a mouse cursor to select a desired category or subcategory.

Utilizing conventional data entry fields, the SELLER is also prompted to provide a tide for the auction item, a brief and a more detailed description of the item, and key words that a potential buyer might use when searching for the item. As well, the seller is prompted to provide information on the attributes of file 10, including the file type (e.g. .doc, .pdf, etc.).

(4) Still utilizing conventional data entry fields, the SELLER is also prompted to provide an initial ask price for the item and, for the purpose of controlling the auction process in an enhanced manner, to provide criteria to be used in determining whether and by how much to raise or lower the ask price in response to market activity, and criteria to be used in determining whether to close or stop the auction. In a preferred embodiment, the HOST prompts the SELLER for the following criteria in six conventional data entry fields:

(i) Bid Parameter Field: The Bid Parameter is a number which corresponds to the number of bids needed. If, for example, the SELLER sets this number at 2 in the data entry field for the Bid Parameter, then the ask price will be automatically raised by a predetermined amount if 2 bids at least equal to the ask price are received within a predetermined period of time.

(ii) Time Parameter Field: The Time Parameter corresponds to the number of days allowed to get the needed bids. If, for example, the SELLER sets this number at 7 in the data entry field for the Time Parameter, then the ask price will be automatically lowered by a predetermined amount if the Bid Parameter is not met within 7 days.

Together, the number of bids made and the time frame in which they are received represents a measure of the level of market activity.

(iii) Drop Ask Field: This field corresponds to the predetermined amount by which the SELLER's current ask price will be lowered or droppedif the Bid Parameter is not met within the required period of time. Preferably, this amount is expressed as percentage (for example 80%) of the current ask price.

(iv) Raise Ask Field: This field corresponds to the predetermined amount by which the SELLER's current ask price will be raised if the Bid Parameter is met within the required period of time. Preferably, this amount is likewise expressed as a percentage (for example 120%) of the current ask price.

(v) Minimum Bid Field: This field is an amount that corresponds to the minimnum bid which the SELLER is prepared to accept without reconsideration of his or her position. If the ask price automatically drops below this amount, then the auction is automatically closed. The SELLER may then take time to consider whether the auction item (file 10) was significantly overvalued, inadequately described, or otherwise, and whether to restart the auction with new or amended criteria.

(vi) Maximum Bid Field: This field is an amount that corresponds to the maximum bid which the SELLER is prepared to accept without reconsideration of his or her position. If the ask price automatically increases above this amount, then the auction is automatically closed. The SELLER may then take the time to consider whether the auction item (file 10) was significantly undervalued, and whether to restart the auction with new or amended criteria.

(5) The SELLER is prompted by the HOST to upload the information entered under steps (3) and (4) above and, as well, to upload the auction item itself (viz. file 10).

Such information is stored by the HOST in a database linked in a conventional manner with the SELLER established under step (2). The auction item (file 10) is likewise stored in a database linked in a conventional manner with the SELLER.

Note that all the information entered under steps (2) and (3) may be considered as information relating to the data represented by file 10. Also, it will be understood that the process of registering with the HOST and the process of uploading file 10 and related information need not be completed during a single session on the Internet. The SELLER may elect to register during one session, and to upload file 10 and related information during a subsequent session.

In relation to the BUYER, the preferred method of implementing the auction process is as follows:

(1) In the same manner as the SELLER at terminal t₁ the BUYER at terminal tₙ first establishes a communications link via the Internet by going to the web site associated with the HOST.

(2) The HOST prompts inviting the BUYER to review or browse auctions currently in progress.

A first form of prompt is by means of menu selection of a main category of interest (e.g. the category “Agriculture” as indicated above). Upon the BUYER'S selection of a given category, the selection is treated by the HOST as an information request command. The HOST responds by transmitting information on all current auction items within that category to terminal tₙ for display at terminal tₙ. The list may be shortened by further selection from any one or more subcategory menus that also may be presented to the BUYER.

A second form of prompt is by means of a conventional data entry field for entering a key word or words that are of interest, together with a conventional screen button whereby the BUYER instructs the HOST to conduct a search for current auctions items described by such a key word or words, and to display a list of the hits that are found. This action by the BUYER likewise may be considered as an information request command.

In either case, the list which is displayed preferably includes only the titles of the auction items as provided by respective sellers, the current ask price for each item, and the number of bids placed for the item. Each title is controlled in a conventional manner as a hyperlink. If the BUYER clicks on the title at terminal the HOST responds with a new page that displays more detailed information relating to the item.

In the present example, it is presumed that the BUYER has first identified the title for file 10 as provided to the HOST by the SELLER. Upon clicking the title hyperlink for file 10, the more detailed information which is displayed preferably includes the brief and more detailed descriptions provided by the SELLER, the initial ask price for the item, the current ask price, the total number of bids, and the bid range. As well, the more detailed information preferably includes identification of the file type as provided by the SELLER at first instance, information on file size (e.g. 160 kb), and a system file number as assigned to file 10 by the HOST.

(3) If the BUYER does not already have an ID name and password recognized by the HOST, then in order to submit a bid the BUYER is prompted to register with the HOST in the same manner as the SELLER-including the provision of suitable credit card information. As in the case of the SELLER, the information provided is encrypted and stored in the registrant's database.

(4) Having registered, the BUYER is also prompted to enter the following information in conventional data entry fields and to transmit such information to the HOST.

(i) the BUYER's ID name;

(ii) the BUYER's password;

(ii) a bid amount for the item (file 10);

(iv) a time period (e.g. 2 days) after which the bid will be considered withdrawn.

The HOST continually analyzes and updates the SELLER's current ask price in accordance with the criteria set by the SELLER. If at any time during the period set by the BUYER, the bid amount equals or exceeds the current ask price, then the HOST generates a signal signifying the receipt of an acceptable bid. This signal is a simple logic signal in response to the question “Is bid>+ask?”, and preferably triggers the following actions:

(1) An automatic draw on the BUYER's credit card account for the amount bid.

(2) An automatic credit to the SELLER's credit card account for the amount bid less charges by the HOST.

(3) An automatic e-mail message notifying the SELLER that the transaction has occurred.

(4) An automatic e-mail message notifying the BUYER that the transaction has occurred and, further, instructing the BUYER on how to access and download the item purchased (file 10) from the HOST.

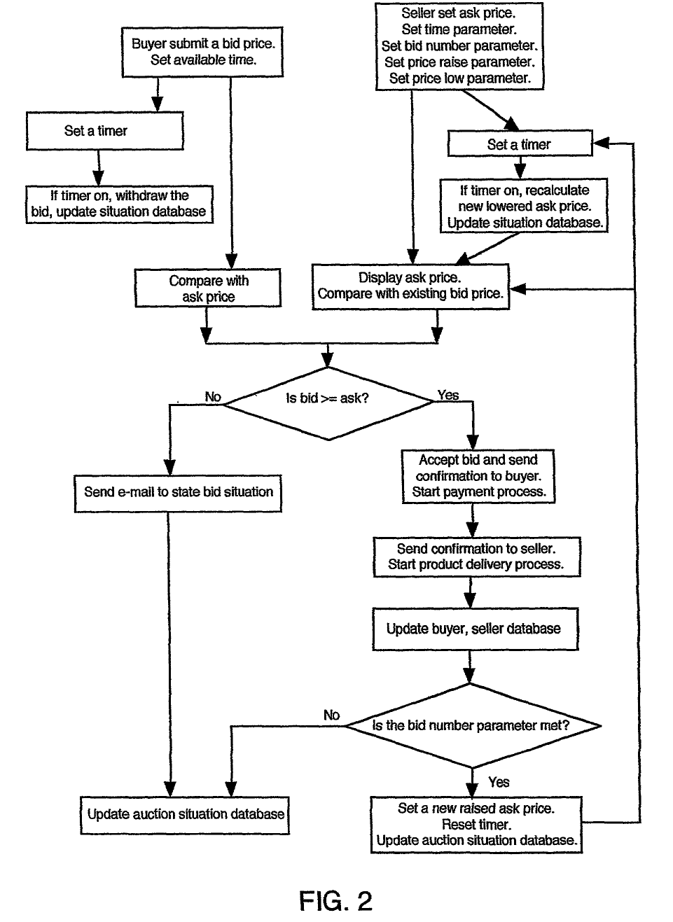

Basic elements of the auction process described above are illustrated in the flow chart shown in FIG. 2, all the steps indicated being resident within server computer system 2 (viz. the HOST).

The foregoing SELLER and BUYER implementations presume a virtually unlimited supply of the auction item (file 10) and allow both the SELLER and the BUYER to continually review and to exercise varying auction strategies in response to their respective assessment of market demand and changing market circumstances for the auction item.

A variety of modifications, changes and variations to the invention are possible within the spirit and scope of the following claims. The invention should not be considered as restricted to the specific embodiment which has been described and illustrated with reference to the drawings.

1. In a digital communications network wherein a server computer system is operatively linkable for bidirectional communications with a plurality of remote terminals, each remote terminal being under the control of a user of the network, a method of offering an item by auction to such users, said method comprising the steps of:
(a) storing item information relating to said item in said server computer system, said item information including:
(i) information identifying said item; and
(ii) information representing a current ask pnce for the item;
(b) in response to an information request command from any requesting one of said terminals, transmitting said item information from said server computer system to said requesting terminal for display by said requesting terminal;
(c) receiving at said server computer system bid information transmitted from said remote terminals, said bid information including:
(i) information identifying the user sending tile bid information;
(ii) information representing the amount bid by such user, and,
(d) analyzing with said server computer system bid information so received and, in response thereto:
(i) automatically raising said current ask price by a controlled amount if a predetermined criteria for doing so is satisfied;
(ii) automatically lowering said current ask price by a controlled amount if a predetermiined criteria for doing so is satisfied; and,
(iii) automatically generating an acceptance signal signifying the receipt of an acceptable bid in any case where said bid information satisfies predetermined criteria for acceptance.

2. A method as described in claim 1, wherein said item comprises digital data stored in said server computer system.

3. A method as described in claim 2, further including the step of permitting said data to be downloaded from said computer server system to one of said remote terminals by any user submitting an acceptable bid.

4. A method as described in claim 1, 2 or 3 wherein said current ask price is automatically raised if the amounts bid in a predetermined minimum number of bids are at least equal to said current ask price.

5. A method as described in claim 1, 2 or 3, wherein:
(a) said current ask price is automatically raised if the amounts bid in a predetermined minimum number of bids are at least equal to said current ask price; and,
(b) said current ask price is automatically lowered if a predetermined minimum number of bids at least equal to said current ask price are not received within a predetermined period of time.

6. In a digital communications network wherein a server computer system is operatively linkable for bidirectional communications with a plurality of remote terminals, each remote terminal being under the control of a user of the network, a method of offering digital data by auction to such users, said method comprising the steps of:
(a) uploading said data and information relating to said data to said server computer system, said information relating to said data including:
(i) information identifying said data; and
(ii) information representing a current ask price for said data,
(b) in response to an information request command from any requesting one of said terminals, transmitting said item information from said server computer system to said requesting terminal for display by said requesting terminal;
(c) receiving at said server computer system bid information transmitted from said remote terminals, said bid information including:
(i) information identifying the user sending the bid information;
(ii) information representing the amount bid by such user, and,
(d) analyzing with said server computer system bid information so received and, in response thereto,
(i) automatically raising said current ask price by a controlled amount if a predetermined criteria for doing so is satisfied,
(ii) automatically lowering said current ask price by a controlled amount if a predetermined criteria for doing so is satisfied;
(iii) automatically generating an acceptance signal signifying the receipt of an acceptable bid in any case where said bid information satisfies predetermined criteria for acceptance; and,
(iv) permitting said uploaded data to be downloaded from said computer server system to one of said remote terminals by any user submitting an acceptable bid.

7. A method as described in claim 6, wherein said data and information relating to said data are uploaded to said computer server system from one of said remote terminals.

8. A method as described in claim 6 or 7, wherein said current ask price is automatically raised if the amounts bid in a predetermined minimum number of bids are at least equal to said. current ask price.

9. A method as described in claim 6 or 7, wherein:
(a) said current ask price is automatically raised if the amounts bid in a predetermined minimum number of bids are at least equal to said current ask price; and,
(b) said current ask price is automatically lowered if a predetermined minimum number of bids at least equal to said current ask price are not received within a predetermined period of time.
